(19) United States
(12) Patent Application Publication
(10) Pub. No.: US 2024/0282954 A1
(43) Pub. Date: Aug. 22, 2024

(54) POSITIVE ELECTRODE ACTIVE MATERIAL FOR LITHIUM SECONDARY BATTERY, POSITIVE ELECTRODE FOR LITHIUM SECONDARY BATTERY, AND LITHIUM SECONDARY BATTERY

(71) Applicant: SUMITOMO CHEMICAL COMPANY, LIMITED, Tokyo (JP)

(72) Inventor: Tatsuya HANAFUSA, Niihama-shi (JP)

(73) Assignee: SUMITOMO CHEMICAL COMPANY, LIMITED, Tokyo (JP)

(21) Appl. No.: 18/567,019

(22) PCT Filed: Jun. 8, 2022
(86) PCT No.: PCT/JP2022/023105

§ 371 Date: Dec. 4, 2023

(30) Foreign Application Priority Data
Jun. 11, 2021 (JP) 2021-097993

(51) Int. Cl. H01M 4/525; H01M 4/02; H01M 10/052

(52) U.S. Cl. CPC H01M 4/525; H01M 10/052; H01M 2004/021; H01M 2004/028

(57) ABSTRACT

This positive electrode active material for a lithium secondary battery contains a lithium metal composite oxide containing at least Li and Ni, and satisfies (1) and (2):
(1) a pore volume in a range of pore diameter of 2 to 10 nm is 9.0×10⁻⁴ cm³/g or less in a pore diameter distribution in an adsorption isotherm as determined by measurement of an adsorption isotherm and a desorption isotherm of nitrogen gas and a Barrett-Joyner-Halenda method; and
(2) a pore diameter at which a log differential pore volume is a maximum value in a log differential pore volume distribution in a range of pore diameter of 2 to 200 nm based on a pore diameter distribution in a desorption isotherm as determined by measurement of an adsorption isotherm and a desorption isotherm of nitrogen gas and a Barrett-Joyner-Halenda method is more than 10 nm and 200 nm or less.

### TECHNICAL FIELD

The present invention relates to a positive electrode active material for a lithium secondary battery, a positive electrode for a lithium secondary battery, and a lithium secondary battery.

Priority is claimed on Japanese Patent Application No. 2021-097993, filed in Japan on Jun. 11, 2021, the content of which is incorporated herein by reference.

### BACKGROUND ART

A positive electrode active material for lithium secondary batteries is an assembly of secondary particles in each of which a plurality of primary particles aggregate. This results in a plurality of pores present between secondary particles on the surface of positive electrode active materials for lithium secondary batteries. The state of pores of the positive electrode active materials for lithium secondary batteries relates to the characteristics of the lithium secondary batteries.

For example, Patent Document 1 discloses that controlling the volume of pores of 0.2 μm or more and 1.0 μm or less in a positive electrode active material for a lithium secondary battery to be 0.3 mL/g or more and 0.5 mL/g or less keeps initial resistance and resistance increase rate low.

### CITATION LIST

### Patent Document

Patent Document 1: JP-A-2017-191738

### SUMMARY OF INVENTION

### Technical Problem

It is considered that, in positive electrode active materials for lithium secondary batteries, which are assemblies of secondary particles, there are many pores with a small size, specifically pores with a pore diameter of 2 to 10 nm (hereinafter, referred to as “nanopores” in some cases) between the secondary particles. Such nanopores are considered to be thermodynamically unstable. Thus, in a case where positive electrode active materials for lithium secondary batteries containing many nanopores are used for lithium secondary batteries, there is a possibility that changes in the crystal structure of the positive electrode active material may occur during charging and discharging, or irreversible reactions may easily occur. As a result, the discharge capacity may decrease upon repeated charging and discharging of lithium secondary batteries.

The present invention has been made in view of the above-described circumstances, and an object of the present invention is to provide a positive electrode active material for a lithium secondary battery capable of obtaining a lithium secondary battery of which discharge capacity does not easily decrease even after repeated charging and discharging, by reducing the proportion of nanopores in the positive electrode active material for the lithium secondary battery, as well as a positive electrode for a lithium secondary battery and a lithium secondary battery in which the positive electrode active material for the lithium secondary battery is used.

### Solution to Problem

The present invention has the following aspects.

[1] A positive electrode active material for a lithium secondary battery, containing a lithium metal composite oxide containing at least Li and Ni, and satisfying (1) and (2):
(1) a pore volume in a range of pore diameter of 2 to 10 nm is 9.0×10⁻⁴ cm^{3/}g or less in a pore diameter distribution in an adsorption isotherm as determined by measurement of an adsorption isotherm and a desorption isotherm of nitrogen gas and a Barrett-Joyner-Halenda method; and
(2) a pore diameter at which a log differential pore volume is a maximum value in a log differential pore volume distribution in a range of pore diameter of 2 to 200 nm based on a pore diameter distribution in a desorption isotherm as determined by measurement of an adsorption isotherm and a desorption isotherm of nitrogen gas and a Barrett-Joyner-Halenda method is more than 10 nm and 200 nm or less.

[2] The positive electrode active material for the lithium secondary battery according to [1], in which the lithium metal composite oxide is represented by Formula (A).

Li[Liₘ(Ni(₁₋ₙ)Xₙ)₁₋ₘ]O₂ (A)

(In Formula A, X represents one or more elements selected from the group consisting of Co, Mn, Fe, Cu, Ti, Mg, Al, W, Mo, Nb, Zn, Sn, Zr, Ga, V, B, Si, and P, and −0.1≤m≤0.2 and 0≤n≤0.7 are satisfied.)

[3] The positive electrode active material for the lithium secondary battery according to [1] or [2], in which a maximum value of log differential pore volume in a range of pore diameter of 5 nm or less is less than 0.005 cm^{3/}g in the pore diameter distribution in the desorption isotherm.

[4] The positive electrode active material for the lithium secondary battery according to any one of [1] to [3], further containing Na, in which a product of a proportion of a mass of Na to a total mass of the positive electrode active material for the lithium secondary battery and a BET specific surface area of the positive electrode active material for the lithium secondary battery is 2.0×10⁻⁴ m^{2/}g or less.

[5] The positive electrode active material for the lithium secondary battery according to any one of [1] to [4], in which a pore volume in a range of pore diameter of 2 to 200 nm is 2.0×10⁻³ cm^{3/}g or more in the pore diameter distribution in the desorption isotherm.

[6] The positive electrode active material for the lithium secondary battery according to any one of [1] to [5], having a BET specific surface area of 0.5 m^{2/}g or more and less than 1.2 m^{2/}g.

[7] The positive electrode active material for the lithium secondary battery according to any one of [1] to [6], in which a value of S/(V×1000) is less than 0.30 m2/cm³, where S is a BET specific surface area of the positive electrode active material for the lithium secondary battery, and V is a pore volume in a range of pore diameter of 2 to 200 nm.

[8] A positive electrode for a lithium secondary battery, containing: the positive electrode active material for the lithium secondary battery according to any one of [1] to [7].

[9] A lithium secondary battery, containing: the positive electrode for the lithium secondary battery according to [8].

### Advantageous Effects of Invention

According to the present invention, it is possible to provide a positive electrode active material for a lithium secondary battery capable of obtaining a lithium secondary battery of which discharge capacity does not easily decrease even after repeated charging and discharging, as well as a positive electrode for a lithium secondary battery and a lithium secondary battery in which the positive electrode active material for the lithium secondary battery is used.

### BRIEF DESCRIPTION OF DRAWINGS

FIG. 1 is a schematic configuration view showing an example of a lithium secondary battery.

FIG. 2 is a schematic view showing an entire configuration of the all-solid-state lithium secondary battery of the present embodiment.

### DESCRIPTION OF EMBODIMENTS

Hereinafter, a positive electrode active material for a lithium secondary battery in an aspect of the present invention will be described. In a plurality of embodiments to be described below, preferable examples or conditions may be shared. In the present specification, terms are each defined below.

In the present specification, a metal composite compound will be hereinafter referred to as “MCC”, a lithium metal composite oxide will be hereinafter referred to as “LiMO”, a positive electrode active material for a lithium secondary battery will be hereinafter referred to as “CAM” as an abbreviation for a cathode active material for a lithium secondary battery, and a Barrett-Joyner-Halenda method will be hereinafter referred to as “BJH method”.

“Ni” refers not to a nickel metal but to a nickel atom. “Co”, “Li”, “Na”, and the like also, similarly, each refer to a cobalt atom, a lithium atom, a sodium atom, or the like.

“Nanopores” mean pores with a pore diameter of 2 to 10 nm present on the CAM surface.

In a case where a numerical range is expressed as, for example, “1 to 10 μm”, this means a range from 1 μm to 10 μm and means a numerical range including 1 um, which is the lower limit value, and 10 μm, which is the upper limit value.

The “pore diameter” and “pore volume” are determined based on the pore diameter distribution determined from an adsorption isotherm and a desorption isotherm by the BJH method. The BJH method is an approach by which analysis is carried out based on a relational expression (Kelvin equation) between pore diameter where capillary condensation occurs and relative pressure of nitrogen, assuming that the pore shape is cylindrical. The pore diameter distribution determined from a desorption isotherm is derived from bottleneck-shaped pores.

[Measurement of an adsorption isotherm and a desorption isotherm of nitrogen gas] can be measured, for example, by the following gas adsorption method. First, 10 g of CAM is subjected to a vacuum deaeration treatment at 150° C. for 8 hours using a vacuum heating treatment device. After the vacuum deaeration treatment, using a measuring device, an adsorption isotherm of nitrogen gas and a desorption isotherm of nitrogen gas for CAM at the liquid nitrogen temperature (77 K) are measured.

As the vacuum heating treatment device, BELSORP-vacII manufactured by MicrotracBEL Corp. can be used, for example. As the above-described measuring device, BELSORP-mini manufactured by MicrotracBEL Corp. can be used, for example.

The amount of nitrogen adsorbed per unit weight of CAM in the adsorption isotherm is calculated as expressed in volume of gaseous nitrogen under standard conditions (STP; Standard Temperature and Pressure).

The amount of nitrogen desorbed per unit weight of CAM in the desorption isotherm is calculated as expressed in volume of gaseous nitrogen under standard conditions (STP).

The “BET specific surface area” can be calculated by the BET multipoint method using the value of the amount of nitrogen adsorbed up to a relative pressure, p/p₀, of 0.4 in the above-described adsorption isotherm (unit: m²/g).

“Cumulative volume particle diameter” is a value measured by the laser diffraction scattering method. Specifically, 0.1 g of an object to be measured, for example, a powder of MCC or CAM is injected into 50 ml of a 0.2 mass % sodium hexametaphosphate aqueous solution to obtain a dispersion liquid in which the powder is dispersed. Next, the particle diameter distribution of the obtained dispersion liquid is measured using a laser diffraction scattering particle diameter distribution measuring device (for example, MASTERSIZER 2000 manufactured by Malvern Panalytical Ltd.) to obtain a volume-based cumulative particle size distribution curve. In the obtained cumulative particle size distribution curve, the value of the particle diameter at the time of 10% cumulation from the small particle side is the 10% cumulative volume particle diameter (hereinafter, referred to as D₁₀ in some cases) (μm), the value of the particle diameter at the time of 50% cumulation from the small particle side is the 50% cumulative volume particle diameter (hereinafter, referred to as D50 in some cases) (μm), and the value of the particle diameter at the time of 90% cumulation from the small particle side is the 90% cumulative volume particle diameter (hereinafter, referred to as D₉₀ in some cases) (μm).

The “composition analysis of LiMO or CAM” will be analyzed by the following method. For example, after dissolving a CAM powder in hydrochloric acid, the composition of CAM is measured using an ICP emission spectrometer. As the ICP emission spectrometer, Optima 7300 manufactured by PerkinElmer, Inc. can be used, for example. The composition of LiMO can be obtained based on the results of analysis of metal elements (such as Li, Ni, and element M) other than Na by measuring a CAM powder by the method described above.

The “50th discharge capacity” means the value measured after carrying out a test in which charging and discharging cycles are repeated 50 times under the conditions shown below.

Initial charging and discharging of a lithium secondary battery is carried out by constant current constant voltage charging for 5 hours at room temperature with constant current charging at 1 mA to 4.3 V and then constant voltage charging at 4.3 V, followed by constant current discharging at 1 mA to 2.5 V.

The discharge capacity is measured and the value obtained is defined as the “initial discharge capacity” (mAh/g).

The charge capacity is measured and the value obtained is defined as the “initial charge capacity” (mAh/g).

After the initial charging and discharging, charging at 1 mA and discharging at 1 mA are repeated under the same conditions as the initial charging and discharging. After that, the discharge capacity at the 50th cycle (mAh/g) is measured.

In the present specification, a lithium secondary battery with a large 50th discharge capacity may be referred to as having “good cycle characteristics”, meaning that the discharge capacity does not easily decrease even after repeated charging and discharging.

### Positive Electrode Active Material for Lithium Secondary Battery

CAM of the present embodiment contains LiMO containing at least Li and Ni, and satisfies (1) and (2):
(1) the pore volume in the range of pore diameter of 2 to 10 nm is 9.0×10⁻⁴ cm^{3/}g or less in the pore diameter distribution in the desorption isotherm as determined by measurement of the adsorption isotherm and the desorption isotherm of nitrogen gas and the BJH method; and
(2) the pore diameter at which the log differential pore volume is the maximum value in the log differential pore volume distribution in the range of pore diameter of 2 to 200 nm based on the pore diameter distribution in the desorption isotherm is more than 10 nm and 200 nm or less.

CAM in the present embodiment is an assembly of a plurality of particles. In other words, CAM in the present embodiment is powdery. In the present embodiment, the assembly of a plurality of particles may contain only secondary particles or may be a mixture of primary particles and secondary particles.

In the present embodiment, “primary particle” means a particle in which, apparently, no grain boundary is present at the time of observing the particle in a visual field of 5000 times or more and 20000 times or less using a scanning electron microscope or the like.

In the present embodiment, “secondary particle” is a particle in which the primary particles aggregate. That is, a secondary particle is an aggregate of primary particles.

CAM in the present embodiment contains LiMO containing Li and Ni, and the proportion of the mass of LiMO containing Li and Ni may be 98 to 100 mass % and may be 99 to 100 mass % in the total mass of CAM.

CAM of the present embodiment satisfies (1) and (2):
(1) the pore volume (hereinafter, referred to as pore volume A in some cases) in the range of pore diameter of 2 to 10 nm is 9.0×10⁻⁴ cm³/g or less in the pore diameter distribution in the adsorption isotherm as determined by measurement of the adsorption isotherm and the desorption isotherm of nitrogen gas and the BJH method; and
(2) the pore diameter (hereinafter, referred to as pore diameter B in some cases) at which the log differential pore volume is the maximum value in the log differential pore volume distribution in the range of pore diameter of 2 to 200 nm based on the pore diameter distribution in the desorption isotherm as determined by measurement of the adsorption isotherm and the desorption isotherm of nitrogen gas and the BJH method is more than 10 nm and 200 nm or less.

By analyzing the adsorption isotherm and desorption isotherm obtained by the above-described method using the BJH method, the pore volume A, the pore diameter B, the maximum value of log differential pore volume in the range of pore diameter of 5 nm or less to be described below, and the pore volume in the range of pore diameter of 2 to 200 nm to be described below can be determined.

The pore volume A is 9.0×10−4 cm³/g or less, preferably 8.0×10⁻⁴ cm3/g or less, and more preferably 7.0×10⁻⁴ cm³/g or less. When the pore volume A is 9.0×10⁻⁴ cm³/g or less, it can be said that CAM has few nanopores. Nanopores are considered to be thermodynamically unstable. That is, it is considered that, in CAM with few nanopores, changes in the crystal structure do not easily occur during charging and discharging, and irreversible reactions do not easily occur. Consequently, a lithium secondary battery with excellent cycle characteristics can be achieved.

The lower limit value of pore volume A is not particularly limited, but for example, 2.0×10-4 cm3/g is an exemplary example. The upper limit value and lower limit value of pore volume A can be combined together, and the pore volume A is, for example, 2.0×10^{'4} to 9.0×10⁻⁴ cm³/g, preferably 2.0×10⁻⁴ to 8.0×10⁻³ cm³/g, and more preferably 2.0×10⁻⁴ to 7.0×10⁻⁴ cm³/g.

The pore diameter B is more than 10 nm and 200 nm or less, preferably 11 to 190 nm, more preferably 11 to 180 nm, and still more preferably 12 to 180 nm. The pore diameter B being more than 10 nm and 200 nm or less means that CAM has a large proportion of pores with a pore diameter of more than 10 nm and 200 nm or less, and a small proportion of nanopores with a pore diameter of 2 to 10 nm. It is considered that, in CAM with few nanopores, changes in the crystal structure do not easily occur during charging and discharging, and irreversible reactions do not easily occur. Consequently, a lithium secondary battery with excellent cycle characteristics can be achieved.

The maximum value of log differential pore volume in the range of pore diameter of 5 nm or less is preferably less than 0.005 cm³/g, more preferably 0.00001 to 0.003 cm³/g, still more preferably 0.00001 to 0.001 cm³/g, and even still more preferably 0.00002 to 0.001 cm³/g in the pore diameter distribution in the desorption isotherm. When the maximum value of log differential pore volume in the range of pore diameter of 5 nm or less is less than 0.005 cm³/g, it can be said that CAM has few nanopores, and it is considered that changes in the crystal structure do not easily occur during charging and discharging, and irreversible reactions do not easily occur. Consequently, a lithium secondary battery with excellent cycle characteristics can be achieved.

The pore volume in the range of pore diameter of 2 to 200 nm is preferably 2.0×10⁻³ cm³/g or more, more preferably 2.0×10⁻³ to 8.0×10⁻³ cm³/g, still more preferably 2.1×10⁻³ to 8.0×10⁻³ cm³/g, and even still more preferably 2.2×10⁻³ to 7.5×10⁻³ cm³/g in the pore diameter distribution in the desorption isotherm. When the pore volume in the range of pore diameter of 2 to 200 nm is 2.0×10⁻³ cm³/g or more, the contact interface between CAM and electrolytic solution increases, and an increase in the battery resistance at the contact interface during charging and discharging can be suppressed. Accordingly, it is considered that changes in the crystal structure do not easily occur during charging and discharging, and irreversible reactions do not easily occur. Consequently, a lithium secondary battery with excellent cycle characteristics can be achieved.

The D₅₀ of CAM of the present embodiment is preferably 4.0 to 20 μm, more preferably 4.5 to 17 μm, and still more preferably 5.0 to 15 μm. When the D50 of CAM is 4.0 μm or more, disintegration of secondary particles can be suppressed. When secondary particles disintegrate, a newborn surface is generated on the surface of the disintegrated particles, and irreversible decomposition reactions between the particles and electrolytic solution easily occur on this newborn surface. That is, when the D₅₀ of CAM is 4.0 μm or more, irreversible decomposition reactions between the CAM particles and electrolytic solution can be suppressed, and a lithium secondary battery with excellent cycle characteristics can be achieved. When the D₅₀ of CAM is 20 μm or less, it can be said that the secondary particles are in a moderately crushed state. The conditions of crushing, described below, are of a strength that does not disintegrate secondary particles but separates the bonds between secondary particles, and therefore, nanopores between primary particles with irregularities are considered to be reduced.

The BET specific surface area of CAM is preferably 0.50 m²/g or more and less than 1.2 m²/g, more preferably 0.50 to 1.19 m²/g, still more preferably 0.52 to 1.19 m²/g, and even still more preferably 0.55 to 1.18 m²/g. When the BET specific surface area is 0.50 m²/g or more and less than 1.2 m²/g, reactions with the electrolytic solution on the surface of CAM are moderately suppressed. Consequently, the cycle characteristics of the lithium secondary battery can be improved.

The value of S/(V×1000), where S [m²/g] is the BET specific surface area and V [cm³/g] is the pore volume in the range of pore diameter of 2 to 200 nm, is preferably less than 0.30 m²/cm³, more preferably 0.10 to 0.28 m²/cm³, still more preferably 0.10 to 0.26 m²/cm³, and even still more preferably 0.10 to 0.17 m²/cm³. When the value of S/(V×1000) is less than 0.30 m²/cm³, the surface area other than pores is sufficiently small and reactions with the electrolytic solution on the surface of CAM are moderately suppressed. Consequently, the cycle characteristics of the lithium secondary battery can be improved.

CAM further contains Na. Na may be contained in CAM as a compound. Alternatively, Na may be present in the form of a compound or solid solution to LiMO on the surface portion of primary particles in LiMO. The proportion of the mass of Na to the total mass of CAM can be determined by the section “composition analysis of LiMO or CAM” described above. The proportion of the mass of Na to the total mass of CAM is preferably 0.05 to 0.0001 mass %, and more preferably 0.02 to 0.001 mass %. It is preferable that CAM contains Na and the product (Na×BET) of the proportion of the mass of Na to the total mass of CAM and the BET specific surface area of CAM is preferably 2.0×10⁻⁴ m²/g or less, more preferably 0.10×10⁻⁴ to 1.5×10⁻⁴ m²/g, and still more preferably 0.20×10⁻⁴ to 1.1×10⁻⁴ m²/g. When the Na×BET is 2.0×10⁻⁴ m²/g or less, Na contained in CAM is sufficiently reduced and reactions with the electrolytic solution on the surface of CAM are moderately suppressed. Consequently, the cycle characteristics of the lithium secondary battery can be improved. The lower limit value of Na×BET is not particularly limited, but is preferably 0.10×10⁻⁵ m²/g. The upper limit value and lower limit value of Na×BET can be combined together.

LiMO contained in CAM is a metal oxide containing at least Li and Ni and is represented by Composition Formula (A).

Li[Liₘ(Ni₍₁₋ₙ₎Xₙ)₁₋ₘ]O₂ (A)

(In Formula A, X represents one or more elements selected from the group consisting of Co, Mn, Fe, Cu, Ti, Mg, Al, W, Mo, Nb, Zn, Sn, Zr, Ga, V, B, Si, and P, and −0.1 ≤m≤0.2 and 0≤n≤0.7 are satisfied.)

From the viewpoint of obtaining a lithium secondary battery with excellent cycle characteristics, m in Formula (A) is −0.1 or more, more preferably −0.05 or more, and still more preferably more than 0. In addition, from the viewpoint of obtaining a lithium secondary battery having a higher initial coulombic efficiency, m in Formula (A) is 0.2 or less, preferably 0.08 or less, and more preferably 0.06 or less.

The upper limit value and lower limit value of m can be randomly combined together. As the combination, for example, m's of −0.1 to 0.2, more than 0 and 0.2 or less, −0.05 to 0.08, more than 0 and 0.06 or less, and the like are exemplary examples.

From the viewpoint of obtaining a lithium secondary battery having a low battery internal resistance, n in Formula (A) is 0 or more, preferably more than 0, and more preferably 0.005 or more. n in Formula (A) is 0.7 or less, preferably 0.5 or less, and more preferably 0.4 or less.

The upper limit value and lower limit value of n can be randomly combined together. As the combination, for example, 0 to 0.7, more than 0 and 0.7 or less, more than 0 and 0.5 or less, 0.005 to 0.4, and the like are exemplary examples.

From the viewpoint of obtaining a lithium secondary battery having a high cycle retention rate, X is preferably one or more elements selected from the group consisting of Co, Mn, Al, W, B, Nb, and Zr.

Examples of the Composition Formula (A) include a Composition Formula (B)

Li[Liₘ(Ni₍₁₋ₙ₎Xₙ)₁₋ₘ]O₂ (B)

(In Formula B, X represents one or more elements selected from the group consisting of Co, Mn, Al, W, B, Nb, and Zr, and 0<m≤0.06 and 0.005≤n≤0.4 are satisfied.)

The crystal structure of LiMO is a layered structure and more preferably a hexagonal crystal structure or a monoclinic crystal structure.

The hexagonal crystal structure belongs to any one space group selected from the group consisting of P3, P3₁, P3₂, R3, P-3, R-3, P312, P321, P3₁12, P3₁21, P3₂12, P3₂21, R32, P3m1, P31m, P3cl, P31c, R3m, R3c, P-31m, P-31c, P-3ml, P-3c1, R-3m, R-3c, P6, P6₁, P6₅, P6₂, P6₄, P6₃, P-6, P6/m, P6₃/m, P622, P6₁22, P6₅22, P6₂22, P6₄22, P6₃22, P6 mm, P6 cc, P6₃ cm, P6₃mc, P-6m2, P-6c2, P-62m, P-62c, P6/mmm, P6/mcc, P63/mcm, and P6₃/mmc.

In addition, the monoclinic crystal structure belongs to any one space group selected from the group consisting of P2, P2₁, C2, Pm, Pc, Cm, Cc, P2/m, P2₁/m, C2/m, P2/c, P2₁/c, and C2/c.

Among these, in order to obtain a lithium secondary battery having a high discharge capacity, the crystal structure is particularly preferably a hexagonal crystal structure belonging to the space group R-3m or a monoclinic crystal structure belonging to C2/m.

The crystal structure of LiMO can be confirmed by observation using a powder X-ray diffraction measuring instrument (for example, Ultima IV manufactured by Rigaku Corporation).

### Method for producing CAM

Next, the method for producing CAM will be described. The method for producing CAM includes at least production of MCC, mixing of MCC and a lithium compound, preliminary calcining of a mixture of MCC and the lithium compound, crushing of a reaction product obtained by preliminary calcining, and main calcining of a crushed reaction product. The crushing may be performed not after the preliminary calcining but after the main calcining, but as an example, the method in which crushing is performed after the preliminary calcining will be described.

### (1) Production of MCC

MCC may be any of a metal composite hydroxide, a metal composite oxide, and a mixture of these. The metal composite hydroxide and metal composite oxide, as an example, contain Ni and X at a molar ratio represented by the following Formula (A′) and are represented by the following Formula (A″).

Ni:X=(1−n):n (A′)

Ni₍₁₋ₙ₎XₙO_{α}(OH)₂-62 (A″)

(In Formula (A′) and Formula (A″), X represents one or more elements selected from the group consisting of Co, Mn, Fe, Cu, Ti, Mg, Al, W, Mo, Nb, Zn, Sn, Zr, Ga, V, B, Si, and P, and 0≤n≤0.7 is satisfied. In Formula (A″), 0≤α≤3, −0.5≤β≤2, and β−α<2 are satisfied.)

Hereinafter, a method for producing MCC containing Ni, Co, and Al will be described as an example. First, a metal composite hydroxide containing Ni, Co, and Al is prepared. Usually, the metal composite hydroxide can be produced by a well-known batch-type co-precipitation method or a continuous co-precipitation method.

Specifically, a nickel salt solution, a cobalt salt solution, an aluminum salt solution, and a complexing agent are reacted by the continuous co-precipitation method described in JP-A-2002-201028, thereby producing a metal composite hydroxide represented by Ni₍₁₋ₙ₎Co_{y}Al_{z}(OH)₂(y+z=n).

A nickel salt that is a solute of the nickel salt solution is not particularly limited, and, for example, at least one of nickel sulfate, nickel nitrate, nickel chloride, and nickel acetate can be used.

As a cobalt salt that is a solute of the cobalt salt solution, for example, at least one of cobalt sulfate, cobalt nitrate, cobalt chloride, and cobalt acetate can be used.

As an aluminum salt that is a solute of the aluminum salt solution, for example, at least one of aluminum sulfate, aluminum nitrate, aluminum chloride, and aluminum acetate can be used.

The above-described metal salts are used in ratios corresponding to the composition ratio of Ni₍₁₋ₙ₎Co_{y}Al_{z}(OH)₂. That is, the amount of each metal salt is specified so that the mole ratio of Ni, Co, and Al in a mixed solution containing the above-described metal salts corresponds to (1−n):n in Formula (A′). In addition, as the solvent, water is used.

The complexing agent is capable of forming a complex with a nickel ion, a cobalt ion, and an aluminum ion in an aqueous solution, and examples thereof include ammonium ion donors (such as ammonium hydroxide, ammonium sulfate, ammonium chloride, ammonium carbonate, or ammonium fluoride), hydrazine, ethylenediaminetetraacetic acid, nitrilotriacetic acid, uracildiacetic acid, and glycine.

In the production step of the metal composite hydroxide, the complexing agent may or may not be used. In a case where the complexing agent is used, regarding the amount of the complexing agent that is contained in the liquid mixture containing the nickel salt solution, the cobalt salt solution, the aluminum salt solution, and the complexing agent, for example, the mole ratio of the complexing agent to the sum of the mole numbers of the metal salts (a nickel salt, a cobalt salt, and an aluminum salt) is more than 0 and 2.0 or less.

In the co-precipitation method, in order to adjust the pH value of the liquid mixture containing the nickel salt solution, the cobalt salt solution, the aluminum salt solution, and the complexing agent, an alkali metal hydroxide is added to the liquid mixture before the pH of the liquid mixture turns from alkaline into neutral. The alkali metal hydroxide is, for example, sodium hydroxide or potassium hydroxide.

The value of the pH in the present specification is defined as a value measured when the temperature of the liquid mixture is 40° C. The pH of the liquid mixture is measured when the temperature of the liquid mixture sampled from a reaction vessel reaches 40° C. In a case where the sampled liquid mixture is lower than 40° C., the liquid mixture is heated up to 40° C. and the pH is measured. In a case where the sampled liquid mixture exceeds 40° C., the liquid mixture is cooled to 40° C. and the pH is measured.

When the complexing agent in addition to the nickel salt solution, the cobalt salt solution, and the aluminum salt solution is continuously supplied to the reaction vessel, Ni, Co, and Al react with one another, and Ni₍₁₋ₙ₎CoyAl_{z}(OH)₂ is generated.

At the time of the reaction, the temperature of the reaction vessel is controlled within a range of, for example, 20 to 80° C. and preferably 30 to 70° C.

In addition, at the time of the reaction, the pH value in the reaction vessel is set within the range of 9 to 13, preferably 10 to 12.5 when the temperature of the aqueous solution is 40° C., for example, and the pH is controlled within +0.5.

As the reaction vessel that is used in the continuous co-precipitation method, it is possible to use a reaction vessel in which the formed reaction precipitate is caused to overflow for separation.

In a case where the metal composite hydroxide is produced by the batch-type co-precipitation method, examples of the reaction vessel include a reaction vessel not equipped with an overflow pipe, a device equipped with a concentration tank connected to the overflow pipe and having a mechanism in which and a reaction precipitate that has overflowed is concentrated in a concentration tank and circulated to the reaction vessel again and the like.

A variety of gases, for example, an inert gas such as nitrogen, argon, or carbon dioxide, an oxidizing gas such as an air or oxygen, or a gas mixture thereof may be supplied into the reaction vessel.

When the concentration of the metal salts to be supplied to the reaction vessel, reaction temperature, reaction pH, and the like are appropriately controlled, it is possible to control the values of (D₉₀−D₁₀)/D₅₀ of MCC and BET specific surface area of CAM to be finally obtained within the ranges of the present embodiment.

After the above-described reaction, the neutralized reaction precipitate is isolated. For isolation, for example, a method in which a slurry containing the reaction precipitate (that is, co-precipitate slurry) is dehydrated by centrifugation, suction filtration, or the like is used.

The isolated reaction precipitate is washed, dehydrated, dried, and sieved, and the metal composite hydroxide containing Ni, Co and Al is obtained.

The reaction precipitate is preferably washed with water or an alkaline washing liquid. In the present embodiment, the reaction precipitate is preferably washed with an alkaline washing liquid and more preferably washed with an aqueous solution of sodium hydroxide. In addition, the reaction precipitate may be washed using a washing liquid containing a sulfur element. As the washing liquid containing a sulfur element, a sulfate aqueous solution of potassium or sodium or the like is an exemplary example.

When MCC is a metal composite oxide, the metal composite hydroxide is heated to produce a metal composite oxide. Specifically, the metal composite hydroxide is heated at 400 to 700° C. If necessary, a plurality of heating steps may be performed. The heating temperature in the present specification means the set temperature of a heating device. In the case of having a plurality of heating steps, the heating temperature means the temperature when the metal composite hydroxide is heated at the highest holding temperature among individual heating steps.

The heating temperature is preferably 400 to 700° C. and more preferably 450 to 680° C. When the heating temperature is 400 to 700° C., the metal composite hydroxide is sufficiently oxidized, and a metal composite oxide having a BET specific surface area in an appropriate range can be obtained. When the heating temperature is lower than 400° C., there is a concern that the metal composite hydroxide may not be sufficiently oxidized. When the heating temperature exceeds 700° C., there is a concern that the metal composite hydroxide may be excessively oxidized and the BET specific surface area of the metal composite oxide may become too small.

The time for holding at the above-described heating temperature is, for example, 0.1 to 20 hours and preferably 0.5 to 10 hours. The temperature rising rate up to the heating temperature is, for example, 50 to 400° C./hour. In addition, as the heating atmosphere, it is possible to use air, oxygen, nitrogen, argon or a gas mixture thereof.

The inside of the heating device may be under an appropriate oxygen-containing atmosphere. The oxygen-containing atmosphere may be a gas mixture atmosphere of an inert gas and an oxidizing gas or may be in a state in which an oxidizing agent is present in an inert gas atmosphere. When the inside of the heating device is an appropriate oxygen-containing atmosphere, a transition metal that is contained in the metal composite hydroxide is appropriately oxidized, which makes it easy to control the form of the metal composite oxide.

As oxygen or the oxidizing agent in the oxygen-containing atmosphere, a sufficient number of oxygen atoms need to be present in order to oxidize the transition metal.

In a case where the oxygen-containing atmosphere is a gas mixture atmosphere of an inert gas and an oxidizing gas, the atmosphere in the heating device can be controlled by a method in which an oxidizing gas is aerated into the heating device, a method in which an oxidizing gas is bubbled through a liquid mixture, or the like.

As the oxidizing agent, it is possible to use a peroxide such as hydrogen peroxide, a peroxide salt such as permanganate, perchloric acid, hypochlorous acid, nitric acid, halogen, ozone, or the like.

MCC can be produced by the step described above. The (D₉₀−D₁₀)/D₅₀ of MCC is preferably 0.9 to 2.5 μm, and still more preferably 1.0 to 2.0 μm. When the (D₉₀−D₁₀)/D₅₀ of MCC is 0.9 to 2.5 μm, it can be said that the particle diameter of MCC is uniform. When such MCC and a lithium compound are calcined under the conditions described below, each particle of MCC uniformly reacts with the lithium compound and the formation of nanopores derived from primary particles of CAM can be suppressed, and as a result, CAM that satisfies (2) above is easily obtained. In addition, when each particle of MCC uniformly reacts with the lithium compound, the BET specific surface area of CAM can be made small, and reactions with the electrolytic solution on the surface of CAM are moderately suppressed. Consequently, the cycle characteristics of the lithium secondary battery can be improved.

### (2) Mixing of MCC and Lithium Compound

The present step is a step of mixing a lithium compound and MCC to obtain a mixture.

The MCC obtained in the step (1) described above is dried and then mixed with the lithium compound. After dried, the MCC may be appropriately classified.

As the lithium compound that is used in the present embodiment, it is possible to use at least any one of lithium carbonate, lithium nitrate, lithium acetate, lithium hydroxide, lithium oxide, lithium chloride, and lithium fluoride. Among these, any one of lithium hydroxide and lithium carbonate or a mixture thereof is preferable. In addition, in a case where lithium hydroxide contains lithium carbonate, the content of lithium carbonate in lithium hydroxide is preferably 5 mass % or less.

The lithium compound and MCC are mixed in consideration of the composition ratio of a final target product to obtain a mixture. Specifically, the lithium compound and MCC are mixed at ratios corresponding to the composition ratio of Composition Formula (A) described above. The amount (mole ratio) of Li to the total amount 1 of the metal atoms contained in MCC is preferably 1.00 or more, more preferably 1.02 or more, and still more preferably 1.05 or more. The mixture of the lithium compound and MCC is calcined as described later, whereby a calcined product is obtained.

### (3) Preliminary Calcining of Mixture

The mixture of MCC and the lithium compound is preliminary calcined and a reaction product is formed. In the present embodiment, preliminary calcining is calcining at a temperature lower than the calcining temperature in a main calcining described below (when the calcining step described below has a plurality of calcining stages, the calcining temperature in the calcining stage that is conducted at the lowest temperature). As the calcining temperature during the preliminary calcining, for example, the range of 400° C. or higher and lower than 700° C. is an exemplary example. The preliminary calcining may be performed a plurality of times.

A calcining device to be used during the preliminary calcining is a fluidized calcining furnace. As the fluidized calcining furnace, a rotary kiln may be used. In a fluidized calcining furnace, a substance to be calcined (in the present embodiment, a mixture of MCC and the lithium compound) is calcined while being stirred. Therefore, each particle of MCC comes into uniform contact with oxygen and the reaction between each particle of MCC and the lithium compound proceeds uniformly, the formation of nanopores derived from primary particles and pores with a pore diameter of more than 10 nm and 200 nm or less is suppressed, and as a result, CAM that satisfies (1) above is easily obtained. Also, CAM is easily obtained in which the maximum value of log differential pore volume in the range of pore diameter of 5 nm or less is less than 0.005 cm³/g.

For example, the temperature of the preliminary calcining is preferably 400° C. or higher and lower than 700° C., more preferably 500 to 695° C., and still more preferably 600 to 690° C. When the calcining temperature is 400° C. or higher, the reaction between MCC and the lithium compound is accelerated. Also, when the calcining temperature of lower than 700° C., a lithium secondary battery with excellent cycle characteristics can be achieved, even when MCC with a high concentration of Ni is used.

In the present specification, the calcining temperature means the temperature of the atmosphere in a calcining furnace and is the highest temperature of the holding temperatures in the calcining step (hereinafter, referred to as the highest holding temperature in some cases). In the case of a calcining step having a plurality of calcining stages, the calcining temperature means the temperature in heating at the highest holding temperature among individual calcining stage. The upper limit value and lower limit value of the calcining temperature can be randomly combined together.

The holding time in the preliminary calcining is preferably 1.0 to 8.0 hours, more preferably 1.0 to 4.0 hours, and particularly preferably 1.2 to 3.0 hours. When the holding time in the preliminary calcining is 1 hour or longer, the reaction between MCC and the lithium compound can be sufficiently enhanced and the generation of nanopores derived from primary particles can be suppressed. As a result, CAM that satisfies (1) above is easily obtained. When the holding time in the calcining is 8.0 hours or shorter, the volatilization of lithium does not easily occur, and a lithium secondary battery with excellent cycle characteristics can be obtained.

The calcining atmosphere in the preliminary calcining contains oxygen. Specifically, the amount of oxygen supplied with respect to the amount of powder supplied during the preliminary calcining is preferably 0.50 Nm³/kg or more, and more preferably 0.55 to 5.0 Nm³/kg. When the amount of oxygen supplied during the preliminary calcining is 0.50 Nm³/kg or more, the reaction between MCC and the lithium compound progresses appropriately and the bonds between secondary particles do not become too strong. As a result, even when nanopores are formed, the nanopores can be easily reduced by crushing, as described below. As a result, CAM that satisfies (1) above is easily obtained. Also, CAM is easily obtained in which the maximum value of log differential pore volume in the range of pore diameter of 5 nm or less is less than 0.005 cm³/g. The volume in the above-described amount of oxygen supplied indicates the volume under standard conditions.

### (4) Crushing of Reaction Product

A reaction product obtained by preliminary calcining is crushed to the extent that the bonded secondary particles are separated from each other. For example, when the reaction product is crushed to the extent that D₅₀ thereof is 4 to 15 μm after crushing, the nanopores formed by aggregation of primary particles with irregularities can be reduced. As a result, on the other hand, when the crushing is too strong, that is, when the reaction product is crushed until D₅₀ thereof is less than 4 μm after crushing, disintegration of secondary particles occurs, a newborn surface is generated on the surface of the disintegrated particles, and irreversible decomposition reactions between the particles and electrolytic solution easily occur on this newborn surface. By using CAM of the present embodiment, nanopores can be reduced, thus making it easier to obtain CAM that satisfies (2) above. In addition, irreversible decomposition reactions between the CAM particles and electrolytic solution can be suppressed, and a lithium secondary battery with excellent cycle characteristics can be achieved.

The crushing of the reaction product is not particularly limited as long as the means are capable of satisfying the conditions described above, and for example, crushing with a pin mill, disc mill, or the like is an exemplary example. The conditions for the crushing of the reaction product with a pin mill include, for example, operating the pin mill at a rotation speed of 300 to 20000 rpm. The conditions for the crushing of the reaction product with a disc mill include, for example, operating the disc mill at a rotation speed of 12 to 1200 rpm.

By setting the amount of oxygen supplied during the preliminary calcining to the above-described range and by appropriately crushing the reaction product under the conditions described above, nanopores can be reduced, thus making it easier to obtain CAM that satisfies (1) and (2) above.

### (5) Main Calcining of Reaction Product

A crushed reaction product is subjected to main calcining. The main calcining may be performed using either a continuous calcining furnace or a fluidized calcining furnace. As the continuous calcining furnace, a tunnel furnace or a roller hearth kiln is an exemplary example. As the fluidized calcining furnace, a rotary kiln may be used.

As the calcining atmosphere in the main calcining, air, oxygen, nitrogen, argon, a gas mixture thereof, or the like is used depending on a desired composition. When the calcining atmosphere is an oxygen-containing atmosphere, the amount of oxygen supplied with respect to the amount of powder supplied is preferably 0.50 Nm³/kg or more, and more preferably 0.60 Nm³/kg or more. When the amount of oxygen supplied with respect to the amount of powder supplied is 0.50 Nm³/kg or more, the reaction between the unreacted MCC and lithium compound in the reaction product can be sufficiently enhanced, and the generation of nanopores derived from primary particles can be suppressed. As a result, CAM that satisfies (1) above is easily obtained. The amount of oxygen supplied with respect to the amount of powder supplied is not particularly limited as long as it is 0.50 Nm³/kg or more, but from the viewpoint of economic efficiency, for example, it is preferably 30 Nm³/kg or less, and more preferably 20 Nm³/kg.

The main calcining may have a plurality of calcining stages that is performed at different calcining temperatures. For example, a first calcining stage and a second calcining stage of calcining at a higher temperature than in the first calcining stage each may be independently conducted. Furthermore, the calcining step may have a calcining stage that is performed at a different calcining temperature and for a different calcining time.

The calcining temperature of the main calcining is 700° C. or higher, preferably 700 to 1100° C., and more preferably 720 to 1050° C. When the calcining temperature is 700° C. or higher, it is possible to obtain LiMO having a strong crystal structure. In addition, when the calcining temperature is 1100° C. or lower, it is possible to reduce the volatilization of lithium on the surfaces of the secondary particles that are contained in LiMO. Also, when the main calcining is performed with a roller hearth kiln, the reaction product is filled into a housing for calcining. The housing contains a minute amount of Na in some cases, and when the calcining temperature is high, Na may be mixed into the calcined product. Accordingly, when the main calcining is performed with a roller hearth kiln, the calcining temperature is preferably 700 to 1000° C. When the calcining temperature is 700 to 1000° C., the mixing of Na into the calcined product can be suppressed. As a result, the Na×BET of CAM can be adjusted to 2.0×10−4 m²/g or less.

The holding time in the main calcining is preferably 1 to 50 hours. When the holding time in the main calcining is 1 hour or longer, the reaction between the unreacted MCC and lithium compound in the reaction product can be sufficiently enhanced, and the generation of nanopores derived from primary particles can be suppressed. As a result, CAM that satisfies (1) above is easily obtained. When the holding time in the main calcining is 50 hours or shorter, the volatilization of lithium does not easily occur, and a lithium secondary battery with excellent cycle characteristics can be obtained.

The mixture of MCC and the lithium compound may be calcined in the presence of an inert melting agent. The inert melting agent may remain in the calcined product or may be removed by washing with a washing liquid or the like as described below. As the inert melting agent, one described in WO2019/177032A1 can be used.

When the reaction product of MCC and the lithium compound is calcined as described above, LiMO can be obtained.

### (6) Other Steps

After the calcining step, the unreacted lithium compound and inert melting agent remaining may be removed by washing LiMO. For the washing, pure water or an alkaline washing liquid can be used. As the alkaline washing liquid, for example, aqueous solutions of one or more anhydrides selected from the group consisting of lithium hydroxide, sodium hydroxide, potassium hydroxide, lithium carbonate, sodium carbonate, potassium carbonate, and ammonium carbonate and a hydrate thereof can be exemplary examples. In addition, as the alkaline washing liquid, ammonia water can also be used.

The temperature of the washing liquid is preferably 15° C. or lower, more preferably 10° C. or lower, and still more preferably 8° C. or lower. When the temperature of the washing liquid is controlled within the above-described range to an extent that the washing liquid does not freeze, it is possible to suppress the excessive elution of lithium ions from the crystal structure of LiMO into the washing liquid during the washing.

As a method for bringing the washing liquid and LiMO into contact with each other, a method in which LiMO is injected into each washing liquid and stirred is an exemplary example. In addition, a method in which each washing liquid is sprayed to LiMO as a shower water may also be used. Furthermore, a method in which LiMO is injected into the washing liquid and stirred, then, LiMO is separated from each washing liquid, and then each washing liquid is sprayed to the separated LiMO as a shower water may also be used.

In the washing, it is preferable to bring the washing liquid and LiMO into contact with each other for an appropriate range of time. “Appropriate time” in the washing refers to a time long enough to disperse each particle of LiMO while removing the unreacted lithium compound and inert melting agent remaining on the surface of LiMO. The washing time is preferably adjusted depending on the aggregation state of LiMO. The washing time is particularly preferably, for example, in a range of 5 minutes to 1 hour.

The proportion of LiMO in a mixture of the washing liquid and LiMO (hereinafter, referred to as the slurry in some cases) is preferably 10 to 60 mass %, more preferably 20 to 50 mass %, and still more preferably more than 30 mass % and 50 mass % or less. When the proportion of LiMO is 10 to 60 mass %, it is possible to remove the unreacted lithium compound and inert melting agent.

After the washing of LiMO, it is preferable to perform a heat treatment on LiMO. The temperature or method for performing the heat treatment on LiMO is not particularly limited, but is preferably 100° C. or higher, more preferably 130° C. or higher, and still more preferably 150° C. or higher from the viewpoint that it is possible to prevent a decrease in the charge capacity. Also, the upper limit temperature is not particularly limited, but is preferably 700° C. or lower and more preferably 600° C. or lower, to the extent that the crystallite diameter distribution obtained in the calcining step is not affected.

The amount of lithium volatilized can be controlled by the heat treatment temperature.

The upper limit value and lower limit value of the heat treatment temperature can be randomly combined together. For example, the heat treatment temperature is preferably 100 to 700° C., more preferably 130 to 600° C., and still more preferably 150 to 400° C.

As the atmosphere during the heat treatment, an oxygen atmosphere, an inert atmosphere, a reduced pressure atmosphere, or a vacuum atmosphere is an exemplary example. When the heat treatment after the washing is performed in the above-described atmosphere, a reaction between LiMO and moisture or carbon dioxide in the atmosphere during the heat treatment is suppressed, and CAM containing few impurities can be obtained.

CAM can be obtained by the step described above. LiMO after the calcining step may be CAM of the present embodiment.

The production method of the present embodiment has been described as described above, but the present invention is not limited to CAM produced by this production method. Any production method can be applied to the present invention as long as CAM that satisfies (1) and (2) above can be obtained.

For example, in the production method described above, crushing is performed after preliminary calcining, followed by main calcining, but preliminary calcining may be followed by main calcining, and then crushing may be performed. Alternatively, crushing may be performed after preliminary calcining, main calcining, and subsequent washing and heat treatment have taken place. Even in these cases, the conditions for preliminary calcining, main calcining, and crushing can be the same as those for the production method described above.

Among these methods, in a method in which crushing is performed after preliminary calcining, followed by main calcining, or in a method in which crushing is also performed after main calcining, by performing crushing under appropriate conditions, it is easier to obtain CAM that satisfies (1) and (2) above.

### Lithium Secondary Battery

Next, the configuration of a lithium secondary battery that is suitable in a case where CAM of the present embodiment is used will be described.

When CAM of the present embodiment is applied to a lithium secondary battery, it may contain only CAM of the present embodiment as CAM, or it may contain CAM other than CAM of the present embodiment. For example, when CAM other than CAM of the present embodiment is contained as CAM, the content proportion of CAM of the present embodiment to the total mass of CAM (100 mass %) is preferably 70 to 99.9 mass %, and more preferably 80 to 99.8 mass %. Furthermore, a positive electrode (hereinafter, referred to as the positive electrode in some cases) for a lithium secondary battery that is suitable in a case where CAM of the present embodiment is used will be described.

Furthermore, a lithium secondary battery that is suitable for an application of a positive electrode will be described.

An example of the lithium secondary battery that is suitable in a case where CAM of the present embodiment is used has a positive electrode, a negative electrode, a separator interposed between the positive electrode and the negative electrode, and an electrolytic solution disposed between the positive electrode and the negative electrode.

An example of the lithium secondary battery has a positive electrode, a negative electrode, a separator interposed between the positive electrode and the negative electrode, and an electrolytic solution disposed between the positive electrode and the negative electrode.

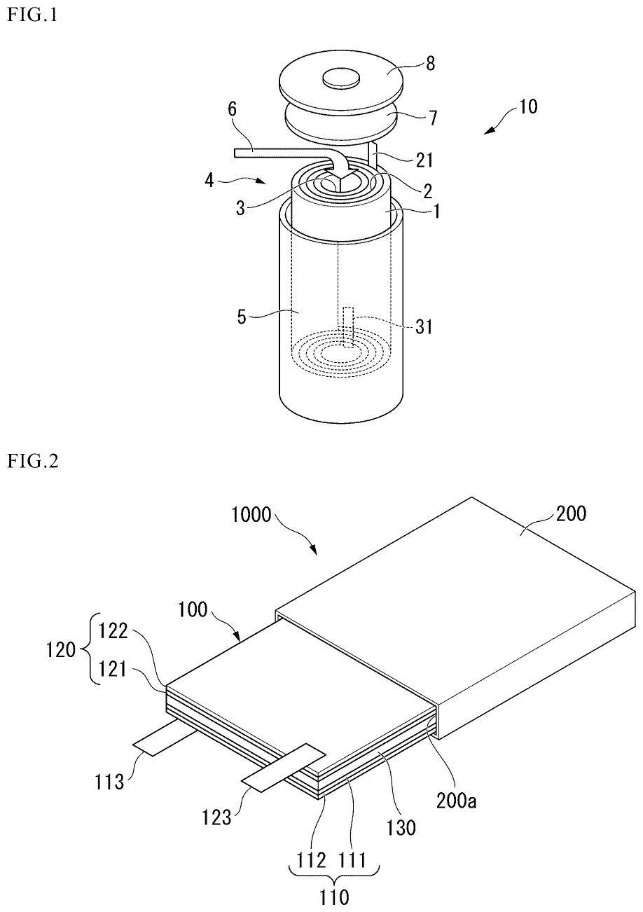

FIG. 1 is a schematic view showing an example of a lithium secondary battery. A cylindrical lithium secondary battery 10 of the present embodiment is produced as described below.

First, as shown in FIG. 1, a pair of separators 1 having a strip shape, a strip- shaped positive electrode 2 having a positive electrode lead 21 at one end, and a strip-shaped negative electrode 3 having a negative electrode lead 31 at one end are laminated in the order of the separator 1, the positive electrode 2, the separator 1, and the negative electrode 3 and are wound to form an electrode group 4.

Next, the electrode group 4 and an insulator, not shown, are accommodated in a battery can 5, and the can bottom is then sealed. The electrode group 4 is impregnated with an electrolytic solution 6, and an electrolyte is disposed between the positive electrode 2 and the negative electrode 3. Furthermore, the upper portion of the battery can 5 is sealed with a top insulator 7 and a sealing body 8, whereby the lithium secondary battery 10 can be produced.

As the shape of the electrode group 4, for example, a columnar shape in which the cross-sectional shape becomes a circle, an ellipse, a rectangle, or a rectangle with rounded corners when the electrode group 4 is cut in a direction perpendicular to the winding axis can be an exemplary example.

In addition, as a shape of the lithium secondary battery having the electrode group 4, a shape specified by IEC60086, which is a standard for a battery specified by the International Electrotechnical Commission (IEC), or by JIS C 8500 can be adopted. For example, shapes such as a cylindrical type and a square type can be exemplary examples.

Furthermore, the lithium secondary battery is not limited to the winding-type configuration and may have a laminate-type configuration in which the laminated structure of the positive electrode, the separator, the negative electrode, and the separator is repeatedly overlaid. As the laminate-type lithium secondary battery, a so-called coin-type battery, button-type battery, or paper-type (or sheet-type) battery can be an exemplary example.

Hereinafter, each configuration will be described in order.

### Positive Electrode

The positive electrode can be produced by, first, preparing a positive electrode mixture containing CAM, a conductive material, and a binder and supporting the positive electrode mixture by a positive electrode current collector.

### Negative Electrode

The negative electrode in the lithium secondary battery needs to be a material which can be doped with lithium ions and from which lithium ions can be de-doped at a potential lower than that of the positive electrode, and an electrode in which a negative electrode mixture containing a negative electrode active material is supported by a negative electrode current collector and an electrode formed of a negative electrode active material alone can be exemplary examples.

For the positive electrode, separator, negative electrode, and electrolytic solution that configure the lithium secondary battery, the configuration, materials, and production method described in to of WO2022/113904A1, for example, can be used.

### All-Solid-State Lithium Secondary Battery

Next, a positive electrode for which CAM according to an aspect of the present invention is used as CAM of an all-solid-state lithium secondary battery and an all-solid-state lithium secondary battery having this positive electrode will be described while describing the configuration of an all-solid-state lithium secondary battery.

FIG. 2 is a schematic view showing an example of an all-solid-state lithium secondary battery of the present embodiment. An all-solid-state lithium secondary battery 1000 shown in FIG. 2 has a laminate 100 having a positive electrode 110, a negative electrode 120, and a solid electrolyte layer 130 and an exterior body 200 accommodating the laminate 100. In addition, the all-solid-state lithium secondary battery 1000 may have a bipolar structure in which CAM and a negative electrode active material are disposed on both sides of a current collector. As specific examples of the bipolar structure, for example, the structures described in JP-A-2004-95400 are exemplary examples. A material that configures each member will be described below.

The laminate 100 may have an external terminal 113 that is connected to a positive electrode current collector 112 and an external terminal 123 that is connected to a negative electrode current collector 122. In addition, the all-solid-state lithium secondary battery 1000 may have a separator between the positive electrode 110 and the negative electrode 120.

The all-solid-state lithium secondary battery 1000 further has an insulator, not shown, that insulates the laminate 100 and the exterior body 200 from each other and a sealant, not shown, that seals an opening portion 200a of the exterior body 200.

As the exterior body 200, a container formed of a highly corrosion-resistant metal material such as aluminum, stainless steel or nickel-plated steel can be used. In addition, as the exterior body 200, a container obtained by processing a laminate film having at least one surface on which a corrosion resistant process has been performed into a bag shape can also be used.

As the shape of the all-solid-state lithium secondary battery 1000, for example, shapes such as a coin type, a button type, a paper type (or a sheet type), a cylindrical type, a square type, and a laminate type (pouch type) can be exemplary examples.

As an example of the all-solid-state lithium secondary battery 1000, a form in which one laminate 100 is provided is shown in the drawings, but the present embodiment is not limited thereto. The all-solid-state lithium secondary battery 1000 may have a configuration in which the laminate 100 is used as a unit cell and a plurality of unit cells (laminates 100) is sealed inside the exterior body 200.

### Positive Electrode

The positive electrode 110 of the present embodiment has a positive electrode active material layer 111 and a positive electrode current collector 112.

The positive electrode active material layer 111 contains CAM, which is one aspect of the present invention described above, and a solid electrolyte. In addition, the positive electrode active material layer 111 may contain a conductive material and a binder.

### Negative Electrode

The negative electrode 120 has a negative electrode active material layer 121 and the negative electrode current collector 122. The negative electrode active material layer 121 contains a negative electrode active material. In addition, the negative electrode active material layer 121 may contain a solid electrolyte and a conductive material. As the negative electrode active material, the negative electrode current collector, the solid electrolyte, the conductive material, and a binder, those described above can be used.

For the all-solid-state lithium secondary battery, the configuration, materials, and production method described in paragraphs to of WO2022/113904A1, for example, can be used.

In the lithium secondary batteries having the configuration as above, since CAM of the present embodiment described above is used, it is possible to improve the cycle characteristics of the lithium secondary batteries for which this CAM is used.

In addition, since the positive electrodes having the above-described configuration have CAM having the above-described configuration, it is possible to improve the cycle characteristics of the lithium secondary batteries.

Furthermore, the lithium secondary batteries having the above-described configuration have the above-described positive electrodes and thus become secondary batteries having high cycle characteristics.

The present invention has the following aspects.
[10] CAM, containing LiMO containing at least Li and Ni, and satisfying (1) and (2):
(1) the pore volume A is 2.0×10⁻⁴ to 8.0×10⁻⁴ cm³/g; and
(2) the pore diameter B is 11 to 180 nm.
[11] CAM according to [10], in which LiMO is represented by Composition Formula (A).

[12] CAM according to [10] or [11], in which the maximum value of log differential pore volume in the range of pore diameter of 5 nm or less is 0.00001 to 0.001 cm³/g.

[13] CAM according to any one of [10] to [12], further comprising Na, in which the Na×BET is 0.20×10⁻⁴ to 1.1×10⁻⁴ m²/g.

[14] CAM according to any one of [10] to [13], in which the pore volume V is 2.0×10⁻³ to 8.0×10⁻³ cm³/g.

[15] CAM according to any one of [10] to [14], in which the BET specific surface area is 0.50 to 1.19 m^{2/}g.

[16] CAM according to any one of [10] to [15], in which the value of S/(V×1000) is 0.10 to 0.28 m²/cm³.

[17] A positive electrode for a lithium secondary battery, containing: CAM according to any one of [10] to [16].

[18] A lithium secondary battery, containing: the positive electrode for the lithium secondary battery according to [17].

Another aspect of the present invention includes the following aspects.
[10′] CAM, containing LiMO containing at least Li and Ni, and satisfying (1) and (2):
(1) the pore volume A is 4.0×10⁻⁴ to 7.0×10⁻⁴ cm³/g; and
(2) the pore diameter B is 12 to 15 nm.
[11′] CAM according to [10′], in which LiMO is represented by Composition Formula (B).
[12′] CAM according to [10′] or [11′], in which the maximum value of log differential pore volume in the range of pore diameter of 5 nm or less is 0.00001 to 0.0001 cm³/g.
[13′] CAM according to any one of [10′] to [12′], further containing Na, in which the Na×BET is 0.20×10⁻⁴ to 0.5×10⁻⁴ m²/g.
[14′] CAM according to any one of [10′] to [13′], in which the pore volume V is 5.0×10⁻³ to 8.0×10⁻³ cm³/g.
[15′] CAM according to any one of [10′] to [14′], in which the BET specific surface area is 0.8 to 1.19 m^{2/}g.
[16′] CAM according to any one of [10′] to [15′], in which the value of S/(V×1000) is 0.10 to 0.20 m²/cm³.
[17′] A positive electrode for a lithium secondary battery, containing: CAM according to any one of [10′] to [16′].
[18′] A lithium secondary battery, containing: the positive electrode for the lithium secondary battery according to [17′].

### EXAMPLES

Hereinafter, the present invention will be described in detail by showing examples, but the present invention is not limited to the following description.

### Composition Analysis

The composition analysis of CAM and LiMO that were produced by a method to be described below and the proportion of the mass of Na were performed in accordance with the method of the section “composition analysis of LiMO or CAM” described above.

### Pore Diameter and Pore Volume

For CAM produced by a method to be described below, the pore volume A, the pore diameter B, the maximum value of log differential pore volume in the range of pore diameter of 5 nm or less, and the value of pore volume V in the range of pore diameter of 2 to 200 nm were determined by analysis using the methods and devices described above.

### Measurement of BET Specific Surface Area

Measurement of the BET specific surface area of CAM produced by a method to be described below was performed by measurement according to the measurement method of the section “BET specific surface area” described above. From the obtained value (S) and the value of the pore volume V described above, S/(V×1000) was calculated. Also, from the obtained value and the proportion of the mass of Na obtained as described above, the product of the BET specific surface area and the proportion of the mass of Na, “Na×BET”, was calculated.

### Cumulative Volume Particle Diameter

The cumulative volume particle diameters D₁₀, D₅₀, and D₉₀ of metal composite oxides produced by methods to be described below were measured according to the measurement method of the section “cumulative volume particle diameter” described above, and from the obtained values, (D₉₀−D₁₀)/D₅₀ was calculated. The D₅₀ of CAM produced by a method to be described below was measured according to the measurement method of the section “cumulative volume particle diameter” described above.

### Production of Positive Electrode for Lithium Secondary Battery

A paste-like positive electrode mixture was prepared by adding and kneading LiMO that was obtained by the production method to be described below, a conductive material (acetylene black), and a binder (PVdF), to achieve a composition of LiMO:conductive material:binder=92:5:3 (mass ratio). During the preparation of the positive electrode mixture, NMP was used as an organic solvent.

The obtained positive electrode mixture was applied to an Al foil having a thickness of 40 μm, which was to serve as a current collector, and dried in a vacuum at 150° C. for 8 hours, thereby obtaining a positive electrode for a lithium secondary battery. The electrode area of the positive electrode for the lithium secondary battery was set to 1.65 cm².

### Production of Lithium Secondary Battery (Coin-Type Half Cell)

The following operation was performed in a glove box under an argon atmosphere.

The positive electrode for the lithium secondary battery produced in the section <Production of positive electrode for lithium secondary battery> was placed on the lower lid of a part for a coin-type battery R2032 (manufactured by Hohsen Corp.) with the aluminum foil surface facing downward, and a laminated film separator (a 16 μm-thick laminate having a heat-resistant porous layer laminated on a polyethylene porous film) was placed on the positive electrode. An electrolytic solution (300 μl) was poured thereinto. The electrolytic solution used was one obtained by dissolving LiPF₆ in a liquid mixture of ethylene carbonate, dimethyl carbonate, and ethyl methyl carbonate in 30:35:35 (volume ratio) so as to be 1 mol/l.

Next, lithium metal was used as a negative electrode, and the negative electrode was placed on the upper side of the laminated film separator. An upper lid was placed through a gasket and caulked using a caulking machine, thereby producing a lithium secondary battery (coin-type half cell R2032; hereinafter, referred to as “coin-type half cell” in some cases).

### 50th Discharge Capacity

For the lithium secondary battery produced by the method described above, the 50th discharge capacity was measured according to the method described in the measurement method of the section “50th discharge capacity” described above.

### Example 1

After water was poured into a reaction vessel equipped with a stirrer and an overflow pipe, an aqueous solution of sodium hydroxide was added thereto, and the liquid temperature was held at 50° C.

A nickel sulfate aqueous solution, a cobalt sulfate aqueous solution, and an aluminum sulfate aqueous solution were mixed together such that the mole ratio of Ni, Co, and Al reached 0.88:0.09:0.03, thereby preparing a raw material liquid mixture

Next, this raw material liquid mixture and an ammonium sulfate aqueous solution, as a complexing agent, were continuously added into the reaction vessel under stirring. An aqueous solution of sodium hydroxide was timely added dropwise such that the pH of the solution in the reaction vessel reached 11.6 (measurement temperature: 40° C., and a reaction precipitate 1 was obtained.

The reaction precipitate 1 was washed, then, dehydrated, dried, and sieved, and a metal composite hydroxide 1 containing Ni, Co and Al was obtained.

The metal composite hydroxide 1 was held and heated at 650° C. for 5 hours in the atmospheric atmosphere and cooled to room temperature, thereby obtaining a metal composite oxide 1.

Lithium hydroxide was weighed so that the amount (mole ratio) of Li with respect to the total amount 1 of Ni, Co, and Al that were contained in the metal composite oxide 1 reached 1.10. The metal composite oxide 1 and lithium hydroxide were mixed to obtain a mixture 1.

This mixture 1 was injected into the furnace core tube of a rotary kiln (manufactured by Noritake Co., Limited, trade name: desktop rotary kiln) and heated under conditions where the amount of oxygen supplied was 0.67 Nm^{3/}kg, the set temperature of the heater heating section of the furnace core tube was 690° C., and the holding time was 1.2 hours, thereby obtaining a reaction product 1 of the metal composite oxide 1 and lithium hydroxide.

The obtained reaction product 1 was crushed using a pin mill (manufactured by Millsystem Co., Ltd., impact mill AVIS-100) under conditions of 7000 rpm.

The crushed reaction product 1 was injected into the furnace core tube of a rotary kiln (manufactured by Noritake Co., Limited, trade name: desktop rotary kiln) and heated under conditions where the amount of oxygen supplied was 1.0 Nm^{3/}kg, the set temperature of the heater heating section of the furnace core tube was 770° C., and the holding time was 1.4 hours, thereby obtaining a calcined product 1.

A slurry produced by mixing the calcined product 1 and pure water adjusted to a liquid temperature of 5° C. such that the proportion of the calcined product weight to the total amount reached 40 mass % was stirred for 20 minutes, washed, then dehydrated, and heat-treated in a nitrogen atmosphere at 250° C. for 10 hours. The moisture remaining after the dehydration was dried to obtain CAM (1).

LiMO in CAM (1) had m=0.02 and n=0.11 in Composition Formula (A), and the element X was Co and Al.

### Example 2

After water was poured into a reaction vessel equipped with a stirrer and an overflow pipe, an aqueous solution of sodium hydroxide was added thereto, and the liquid temperature was held at 50° C.

A nickel sulfate aqueous solution, a cobalt sulfate aqueous solution, and a manganese sulfate aqueous solution were mixed together such that the mole ratio of Ni, Co, and Mn reached 0.60:0.20:0.20, thereby preparing a raw material liquid mixture.

Next, this raw material liquid mixture and an ammonium sulfate aqueous solution, as a complexing agent, were continuously added into the reaction vessel under stirring. An aqueous solution of sodium hydroxide was timely added dropwise such that the pH of the solution in the reaction vessel reached 12.1 (measurement temperature:)40° ° C., and a reaction precipitate 2 was obtained.

The reaction precipitate 2 was washed, then, dehydrated, dried, and sieved, and a metal composite hydroxide 2 containing Ni, Co and Mn was obtained.

Lithium hydroxide was weighed so that the amount (mole ratio) of Li with respect to the total amount 1 of Ni, Co, and Mn that were contained in the metal composite hydroxide 2 reached 1.04. The metal composite hydroxide 2 and lithium hydroxide were mixed to obtain a mixture 2.

This mixture 2 was injected into the furnace core tube of a rotary kiln (manufactured by Noritake Co., Limited, trade name: desktop rotary kiln) and heated under conditions where the amount of oxygen supplied was 0.67 Nm³/kg, the set temperature of the heater heating section of the furnace core tube was 650° C., and the holding time was 1.4 hours, thereby obtaining a reaction product 2 of the metal composite hydroxide 2 and lithium hydroxide.

Next, the obtained reaction product 2 was filled into a saggar made of alumina and heated in the calcining furnace of a roller hearth kiln (manufactured by Noritake Co., Limited, trade name: special atmosphere roller hearth kiln) while holding it in an oxygen atmosphere at 970° C. for 5 hours, thereby obtaining a calcined product 2.

The obtained calcined product 2 was crushed using a pin mill (manufactured by Millsystem Co., Ltd., impact mill AVIS-100) under conditions of 16000 rpm to obtain CAM (2).

LiMO in CAM (2) had m=0.03 and n=0.40 in Composition Formula (A), and the element X was Co and Mn.

### Comparative Example 1

A mixture 1 was obtained by the method described in Example 1. This mixture 1 was filled into a saggar made of alumina and heated in the calcining furnace of a roller hearth kiln (manufactured by Noritake Co., Limited, trade name: special atmosphere roller hearth kiln) while holding it in an oxygen-containing atmosphere at 650° C. for 5 hours, thereby obtaining a reaction product C1 of the metal composite oxide 1 and lithium hydroxide.

Next, the obtained reaction product C1 was filled into a saggar made of alumina and heated in the calcining furnace of a roller hearth kiln (manufactured by Noritake Co., Limited, trade name: special atmosphere roller hearth kiln) while holding it in an oxygen-containing atmosphere at 720° C. for 6 hours, thereby obtaining a calcined product C1.

A slurry produced by mixing the calcined product C1 and pure water adjusted to a liquid temperature of 5° C. such that the proportion of the calcined product weight to the total amount reached 30 mass % was stirred for 20 minutes, washed, then dehydrated, and heat-treated in a nitrogen atmosphere at 250° C. for 10 hours. The moisture remaining after the dehydration was dried to obtain CAM (C1).

LiMO in CAM (C1) had m=0.01 and n=0.11 in Composition Formula (A), and the element X was Co and Al.

### Comparative Example 2

A reaction product 1 was obtained by the method described in Example 1. The reaction product 1 was injected into the furnace core tube of a rotary kiln (manufactured by Noritake Co., Limited, trade name: desktop rotary kiln) and heated under conditions where the amount of oxygen supplied was 1.0 Nm3/kg, the set temperature of the heater heating section of the furnace core tube was 760° C., and the holding time was 1.2 hours, thereby obtaining a calcined product C2.

The calcined product C2 was washed, dehydrated, and heat-treated by the method described in Comparative Example 1 to obtain CAM (C2).

LiMO in CAM (C2) had m=0.01 and n =0.11 in Composition Formula (A), and the element X was Co and Al.

### Comparative Example 3

A metal composite hydroxide 2 was obtained by the method described in Example 2. Lithium carbonate was weighed so that the amount (mole ratio) of Li with respect to the total amount 1 of Ni, Co, and Mn that were contained in the metal composite hydroxide 2 reached 1.26, and potassium sulfate, which was an inert melting agent, was weighed at a such a proportion that the amount (mole ratio) of potassium sulfate with respect to the total amount of the weighed lithium carbonate and potassium sulfate reached 0.10. The metal composite hydroxide 2 and the weighed lithium carbonate and potassium sulfate were mixed to obtain a mixture C3.

The mixture C3 was heated in the calcining furnace of a roller hearth kiln (manufactured by Noritake Co., Limited, trade name: special atmosphere roller hearth kiln) while holding it in an oxygen-containing atmosphere at 925° C. for 5 hours, thereby obtaining a calcined product C3.

A slurry produced by mixing the calcined product C3 and pure water adjusted to a liquid temperature of 5° C. such that the proportion of the calcined product weight to the total amount reached 30 mass % was stirred for 20 minutes, washed, and then dehydrated. Furthermore, using pure water adjusted to a liquid temperature of 5° C., the powder was washed with shower water of twice the weight of the powder, then dehydrated, and dried under reduced pressure under conditions of 80° C. for 15 hours and 150° C. for 9 hours. The moisture remaining after the dehydration was dried to obtain CAM (C3).

LiMO in CAM (C3) had m=0.00 and n=0.36 in Composition Formula (A), and the element X was Co and Mn.

Table 1 shows the following: the calcining devices used in Examples 1 to 2 and Comparative Examples 1 to 3, whether crushing was performed or not, the amount of oxygen supplied during preliminary calcining, the pore volume A, pore diameter B, maximum value of log differential pore volume in the range of pore diameter of 5 nm or less, Na x BET, BET specific surface area, pore volume V, and S/(V×1000) of CAM (1) to (2) in Examples 1 to 2 and CAM (C1) to (C3) in Comparative Examples 1 to 3, the (D₉₀−D₁₀)/D₅₀ of MCC used, and the 50th discharge capacity of the coin-type half cell using each CAM.

TABLE 1

| | | | | Comparative | Comparative | Comparative |
|---|---|---|---|---|---|---|
| | | Example 1 | Example 2 | Example 1 | Example 2 | Example 3 |
| Ni/Co/Mn/Al | mol % | 88/9/0/3 | 60/20/20/0 | 88/9/0/3 | 88/9/0/3 | 60/20/20/0 |
| Preliminary calcining- | — | RK-RK | RK-RHK | RHK-RHK | RK-RK | RHK |
| main calcining | | | | | | |
| Crushing | — | Performed (after | Performed (after | Not | Not | Not |
| | | preliminary | main | performed | performed | performed |
| | | calcining) | calcining) | | | |
| Amount of oxygen | Nm³/kg | 0.67 | 0.67 | 2.5 | 0.67 | — |
| supplied during | | | | | | |
| preliminary | | | | | | |
| calcining | | | | | | |
| Pore volume A | ×10⁻⁴ cm³/g | 6.2 | 3.9 | 9.5 | 8.1 | 11 |
| Pore diameter B | nm | 13.9 | 165 | 9.3 | 7.2 | 187 |
| Maximum value of log | cm³/g | 0.00005 | 0.0008 | 0.0012 | No peak | 0.0019 |
| differential pore | | | | | | |
| volume in pore | | | | | | |
| diameter of 5 | | | | | | |
| nm or less | | | | | | |
| Na × BET | ×10⁻⁴ m²/g | 0.25 | 0.99 | 0.48 | 0.24 | 0.19 |
| BET | m²/g | 1.18 | 0.55 | 1.72 | 1.31 | 1.89 |
| Pore volume V | ×10⁻³ cm³/g | 7.4 | 2.3 | 7.9 | 6.1 | 11.5 |
| S/(V × 1000) | [m²/cm³] | 0.16 | 0.24 | 0.22 | 0.22 | 0.16 |
| (D₉₀ − | — | 0.96 | 1.10 | 0.90 | 0.90 | 1.67 |
| D₁₀)/D₅₀ | | | | | | |
| D₅₀ | μm | 13.3 | 5.4 | 12.1 | 15.3 | 8.2 |
| 50^{th} discharge capacity | mAh/g | 170.7 | 154.2 | 146.4 | 142.3 | 106.8 |

In the calcining step of Examples 1 to 2, preliminary calcining was performed using the rotary kiln under conditions where the amount of oxygen supplied was 0.50 Nm/kg or more. Furthermore, crushing was performed after preliminary calcining or after main calcining. Such CAM satisfied (1) and (2) above. Moreover, the 50th discharge capacity of the coin-type half cells using CAM (1) to (2) was 154 mAh/g or more.

On the other hand, in Comparative Example 1, in which the roller hearth kiln was used for preliminary calcining, (1) was not satisfied, and the pore volume A was 9.5 nm. It is considered that the mixture did not flow during the preliminary calcining and the secondary particles were in contact with each other for a long time, resulting in progress of sintering between the secondary particles and formation of many nanopores. It is also considered that the nanopores formed between the secondary particles were not lost due to the lack of crushing.

In Comparative Example 3, in which preliminary calcining was not performed and the roller hearth kiln was used for main calcining, (1) was not satisfied, and the pore volume A was 11 nm. As in Comparative Example 1, it is considered that the mixture did not flow during the calcining and the secondary particles were in contact with each other for a long time, resulting in progress of sintering between the secondary particles and formation of many nanopores. It is also considered that the nanopores formed between the secondary particles were not lost due to the lack of crushing.

In Comparative Example 2, in which crushing was not performed, (2) was not satisfied, and the pore diameter B was 7.2 nm. It is considered that the nanopores formed between the secondary particles were not lost due to the lack of crushing.

The 50th discharge capacity of the coin-type half cells using the above CAM (C1) to (C3) was 147 mAh/g or less.

### INDUSTRIAL APPLICABILITY

According to the present invention, it is possible to provide a positive electrode active material for a lithium secondary battery capable of obtaining a lithium secondary battery of which discharge capacity does not easily decrease even after repeated charging and discharging, as well as a positive electrode for a lithium secondary battery and a lithium secondary battery in which the positive electrode active material for the lithium secondary battery is used.

### REFERENCE SIGNS LIST

1: Separator, 2: Positive electrode, 3: Negative electrode, 4: Electrode group, 5: Battery can, 6: Electrolytic solution, 7: Top insulator, 8: Sealing body, 10: Lithium secondary battery, 21: Positive electrode lead, 31: Negative electrode lead, 100: Laminate, 110: Positive electrode, 111: Positive electrode active material layer, 112: Positive electrode current collector, 113: External terminal, 120: Negative electrode, 121: Negative electrode active material layer, 122: Negative electrode current collector, 123: External terminal, 130: Solid electrolyte layer, 200: Exterior body, 200a: Opening portion, 1000: All-solid-state lithium secondary battery

1. A positive electrode active material for a lithium secondary battery, comprising a lithium metal composite oxide containing at least Li and Ni, and satisfying (1) and (2):
(1) a pore volume in a range of pore diameter of 2 to 10 nm is 9.0×10⁻⁴ cm³/g or less in a pore diameter distribution in an adsorption isotherm as determined by measurement of an adsorption isotherm and a desorption isotherm of nitrogen gas and a Barrett-Joyner-Halenda method; and
(2) a pore diameter at which a log differential pore volume is a maximum value in a log differential pore volume in a range of pore diameter of 2 to 200 nm based on a pore diameter distribution in a desorption isotherm as determined by measurement of an adsorption isotherm and a desorption isotherm of nitrogen gas and a Barrett-Joyner-Halenda method is more than 10 nm and 200 nm or less.

2. The positive electrode active material for the lithium secondary battery according to claim 1,
wherein the lithium metal composite oxide is represented by Formula (A),
Li[Liₘ(Ni₍₁₋ₙ)Xₙ)₁₋ₘ]O₂ (A)
(in Formula A, X represents one or more elements selected from the group consisting of Co, Mn, Fe, Cu, Ti, Mg, Al, W, Mo, Nb, Zn, Sn, Zr, Ga, V, B, Si, and P, and −0.1≤m≤0.2 and 0≤n≤0.7 are satisfied.)

3. The positive electrode active material for the lithium secondary battery according to claim 1,
wherein a maximum value of log differential pore volume in a range of pore diameter of 5 nm or less is less than 0.005 cm³/g in the pore diameter distribution in the desorption isotherm.

4. The positive electrode active material for the lithium secondary battery according to claim 1
further comprising Na,
wherein a product of a proportion of a mass of Na to a total mass of the positive electrode active material for the lithium secondary battery and a BET specific surface area of the positive electrode active material for the lithium secondary battery is 2.0×10⁻⁴ m²/g or less.

5. The positive electrode active material for the lithium secondary battery according to claim 1,
wherein a pore volume in a range of pore diameter of 2 to 200 nm is 2.0×10⁻³ cm³/g or more in the pore diameter distribution in the desorption isotherm.

6. The positive electrode active material for the lithium secondary battery according to claim 1,
wherein a BET specific surface area of 0.5 m²/g or more and less than 1.2 m²/g.

7. The positive electrode active material for the lithium secondary battery according to claim 1,
wherein a value of S/(V×1000) is less than 0.30 m²/cm³, where S is a BET specific surface area of the positive electrode active material for the lithium secondary battery, and V is a pore volume in a range of pore diameter of 2 to 200 nm.

8. A positive electrode for a lithium secondary battery, comprising:
the positive electrode active material for the lithium secondary battery according to claim 1.

9. A lithium secondary battery, comprising:
the positive electrode for the lithium secondary battery according to claim 8.

10. The positive electrode active material for the lithium secondary battery according to claim 2,
wherein a maximum value of log differential pore volume in a range of pore diameter of 5 nm or less is less than 0.005 cm³/g in the pore diameter distribution in the desorption isotherm.

11. The positive electrode active material for the lithium secondary battery according to claim 2,
further comprising Na,
wherein a product of a proportion of a mass of Na to a total mass of the positive electrode active material for the lithium secondary battery and a BET specific surface area of the positive electrode active material for the lithium secondary battery is 2.0×10⁴ m²/g or less.

12. The positive electrode active material for the lithium secondary battery according to claim 2,
wherein a pore volume in a range of pore diameter of 2 to 200 nm is 2.0×10⁻³ cm³/g or more in the pore diameter distribution in the desorption isotherm.

13. The positive electrode active material for the lithium secondary battery according to claim 2,
wherein a BET specific surface area of 0.5 m²/g or more and less than 1.2 m²/g.

14. The positive electrode active material for the lithium secondary battery according to claim 2,
wherein a value of S/(V×1000) is less than 0.30 m^{2/}cm³, where S is a BET specific surface area of the positive electrode active material for the lithium secondary battery, and V is a pore volume in a range of pore diameter of 2 to 200 nm.

15. A positive electrode for a lithium secondary battery, comprising:
the positive electrode active material for the lithium secondary battery according to claim 2.

16. A lithium secondary battery, comprising:
the positive electrode for the lithium secondary battery according to claim 15.
